(19) United States
(12) Patent Application Publication
(10) Pub. No.: US 2002/0065718 A1
(43) Pub. Date: May 30, 2002

(54) Advertisement method and advertisement device

(76) Inventors: Koji Otani, Kyoto (JP); Akinori Iwakawa, Kawasaki (JP); Takashi Ohno, Kawasaki (JP); Satoshi Okuyama, Kawasaki (JP); Jun Kakuta, Kawasaki (JP); Madoka Mitsuoka, Kawasaki (JP); Satoru Watanabe, Kawasaki (JP)

Correspondence Address: STAAS & HALSEY LLP, 700 11TH STREET, NW, SUITE 500, WASHINGTON, DC, 20001, US

(21) Appl. No.: 09/815,051

(22) Filed: Mar. 23, 2001

(30) Foreign Application Priority Data
Nov. 30, 2000 (JP) 2000-364371

(51) Int. Cl. G06F 17/60

(52) U.S. Cl. 705/14

(57) ABSTRACT

When a new customer appears in a shop, the customer is registered in an advertisement server 1 with shop terminal 2. When the customer registers an advertiser in his buddy list, an advertisement is distributed to user terminal 4. Namely, by registering an advertisement of the advertiser in buddy list system 4 as if the advertisement of the advertiser is status information of the advertiser, the advertisement is distributed to the user terminal 4 via the buddy list system 3. To persuade a customer to register an advertiser in his buddy list, the advertiser provides an incentive for a customer registering the advertiser in his buddy list (hereinafter referred to as registration customer). Incentive is, for example, adding a premium to points granted to the customer according to purchase history.

### BACKGROUND OF THE INVENTION

1. Technical Field

The present invention relates to network advertisement methods. More specifically, the present invention relates to technologies for advertising on status information managing systems where users can refer to status of other users via networks.

In the present invention, status information managing systems are configured by connecting a plurality of user terminals via a network. These systems obtain information on user status via a network and correlatively record status information per each user. A user terminal can request and obtain status information on a desired user. Among such status information managing systems, more preferable are those in which, by registering user groups in advance, when the system is connected, status information on the user groups can be obtained and displayed on a list.

2. Description of Related Art

In these years, an incentive program on a network is becoming very popular. For example, 1: placing an advertisement on an advertiser's homepage, 2: placing a banner advertisement on a webpage, 3: sending direct mail to a user by e-mail or instant message, and 4: distributing an incentive such as a coupon are incentive programs.

In examples 1 and 2, the system customizes advertisements according to the pre-registered personal information or user activity on the site. Consequently, an advertiser can make more effective advertisement. In example 4, an incentive such as discount is provided by showing a hard copy of homepage on which a coupon is displayed or a screen of a mobile terminal displaying the above-mentioned coupon to a clerk.

An incentive program such as customer service and point service is available in a substantial shop and a virtual shop on a network. In these programs, a member user can get incentives according to his purchase history. Also, in this program, users must register his personal information such as his address and shops can send a direct mail according to this information. In this way, this information is utilized for marketing.

The above-mentioned incentive program using a network is effective to a certain extent, but has the following problems. At first, a user never sees an advertisement unless the user accesses a homepage if the advertisement is placed on the homepage. In other words, only a small number of users have a chance to see an advertisement.

A banner advertisement is basically for an unspecified number of users. Therefore, it is not suitable to find a new customer or to increase or maintain a repeater,or good customers.

An E-mail and an instant message are diffused as a communication means for providing private communication among users. Therefore, an advertisement irrelevant to users is less effective. Conversely, users often feel antipathy to distribution of an advertisement itself via such personal communication means. Thus, there exists a consensus that an advertisement is not supplied to users other than applicants. Consequently, users hoping for an advertisement via such communication media possibly decrease unless an incentive is given to the users.

Sending direct mail from a substantial or virtual shop is effective but costly. Therefore, advertisement frequency is few or it is difficult to coordinate contents of an advertisement according to purchase history.

### SUMMARY OF THE INVENTION

The object of the present invention is to provide cost-effective advertisement technologies allowing effective collection and maintenance of a good customer.

To solve the above-mentioned problems, the present invention provides an advertisement method allowing distribution of an advertisement as status information of an advertiser. Namely, a first aspect of the present invention provides an advertisement method using a buddy list system in which a first computer terminal operated by a first user stores in a buddy list a second user operating a second computer terminal connected to the first computer terminal via a network, and the first computer obtains and then outputs the status information of the second user via the network, comprising:

a step for obtaining data of an advertiser hoping for distribution of advertisement data;

a step for presenting the data of the advertiser as an advertiser list on the first user terminal;

a step for selecting the advertiser from the advertiser list and registering the advertiser in the buddy list;

a step for sending the advertisement data as status information of the advertiser registered in the buddy list; and

a step for displaying the advertisement data on the first computer terminal via the network when the first computer terminal is connected to the buddy list system.

A second aspect of the present invention provides an advertisement method using a status information managing system that correlatively stores users including a first user operating a first computer terminal and second user operating a second computer terminal and status information of the users, and distributes the status information of the second user to the first computer terminal in response to a request from the first computer terminal, comprising:

a step for registering an advertiser as one of the users over the status information managing system;

a step for storing correlatively in a customer table customers of the advertiser, personal information on the customers, and whether or not each of the customer is an advertisement customer hoping for distribution of advertisement data of the advertiser;

a step for storing correlatively in an advertisement table customer types obtained from the personal information and advertisement data;

a step for registering the first user as an advertisement customer in the customer table if the advertiser receives a report that the first user hopes for distribution of status information of the advertiser;

a step for extracting an advertisement customer from the advertisement table and setting it as a destination when the advertiser distributes status information of the advertiser itself over the status information managing system;

a step for determining advertisement data to be provided for the extracted advertisement customer according to customer type obtained from personal information of the advertisement customer and the advertisement table; and

a step for distributing the advertisement data to the advertisement customer as status information of the advertiser by correlatively reporting the advertisement customer and the advertisement data to the status information managing system.

A third aspect of the present invention provides an advertisement device which is used with a status information managing system that correlatively stores users including a first user operating a first computer terminal and second user operating a second computer terminal and status information of the users, and distributes the status information of the second user to the first computer terminal in response to a request from the first computer terminal, comprising:

a connection means connecting to the status information managing system by using an identification number for connecting to the status information managing system;

a customer table correlatively storing customers of an advertiser, personal information on the customers, and whether or not each of the customers is an advertisement customer hoping for distribution of advertisement data of the advertiser;

an advertisement table correlatively storing customer types obtained from the personal information and the advertisement data;

an updating means registering the first user in the customer table as an advertisement customer when receiving a report that the first user hopes for distribution of status information of the advertiser from the status information managing system;

an extraction means extracting the advertisement customer from the advertisement table to set the advertisement customer as a destination if the advertiser distributes status information of the advertiser itself over the status information managing system;

a determination means determining advertisement data to be provided for the extracted advertisement customer according to customer type obtained from personal information of the advertisement customer and the advertisement table; and

a distribution means distributing the advertisement data to the advertisement customer as status information of the advertiser by correlatively reporting the advertisement customer and the advertisement data to the status information managing system.

A fourth aspect of the present invention provides the advertisement device according to the third aspect, wherein the customer table further stores purchase history of the customers and the advertisement table further stores advertisement data according to the purchase history.

A fifth aspect of the present invention provides a computer-readable recording medium recording an advertisement program executed on an advertising device, wherein the advertising device is used with a status information managing system that correlatively stores users including a first user operating a first computer terminal and second user operating a second computer terminal and status information of the users, and distributes the status information of the second user to the first computer terminal in response to a request from the first computer terminal, the advertisement program executing:

a step for connecting to the status information managing system by using an identification number for connecting to the status information managing system;

a step for correlatively in a customer table customers of an advertiser, personal information on the customers, and whether or not each of the customer is an advertisement customer hoping for distribution of advertisement data of the advertiser;

a step for storing correlatively in an advertisement table customer types obtained from the personal information and the advertisement data;

a step for registering the first user in the customer table as an advertisement customer when receiving a report that the first user hopes for distribution of status information of the advertiser from the status information managing system;

a step for extracting the advertisement customer from the advertisement table to set the advertisement customer as a destination if the advertiser distributes status information of the advertiser itself over the status information managing system;

a step for determining advertisement data to be provided for the extracted advertisement customer according to customer type obtained from personal information of the advertisement customer and the advertisement table; and

a step for distributing the advertisement data to the advertiser customer as status information of the advertiser by correlatively reporting the advertisement customer and the advertisement data to the status information managing system.

Herein a computer-readable medium is preferably a floppy disk, hard disk, semiconductor memory, CD-ROM, DVD, MO, etc.

A sixth aspect of the present invention provides a computer terminal which can send and receive data to and from an advertisement device storing customer information on customers of an advertiser, comprising:

an input means accepting input of customer information of one of the customers including a customer ID allotted to the customer by the advertiser and/or a system ID for identifying the customer over a status information managing system; and

a report means reporting customer information accepted to the advertisement device.

A seventh aspect of the present invention provides an advertisement method using a buddy list system where a first user registers a second user in a buddy list whom the first user would like to refer to in a buddy list, obtains status information of the second user, and thus can refer to the status information of the second user; comprising:

a step for registering advertisement data as status information of an advertiser to be distributed over the buddy list as status information of the advertiser; and

a step for distributing the advertisement data to the advertiser's customers by using the buddy list system.

Advertisement data are distributed by a buddy list system as status information.

An eighth aspect of the present invention provides an advertisement device connectable to a buddy list system for a first user to refer to status information of a second user, comprising:

a customer table storing customer IDs for identifying each of customers of an advertiser and IDs for identifying the customers over a buddy list system (hereinafter referred to as buddy ID);

an advertisement table storing advertisement data the advertiser distributes to the customers;

updating means updating the customer table when a new customer appears; and

a registration means registering the advertisement data in the buddy list system.

When information on a new customer is inputted, the storing means writes the information in the customer table.

Advertisement data are sent to the buddy list system as status information of the advertiser. As status information of the advertiser, the buddy list system distributes the advertisement data to customers registering the advertiser as their buddy.

A ninth aspect of the present invention provides the advertisement device according to the eighth aspect, wherein the customer table further stores registration information indicating whether or not each of the customers registers the advertiser in his/her buddy list;

the updating means further updates the customer table when the buddy list system reports that the registration information is changed; and

the updating means further comprises a creation means creating incentive information for the customer according to the registration information.

In this device, the customer table is made to have registration information and incentive is provided for the customer according to the information. By doing so, an advertiser is expected to be registered in a buddy list of a customer. For example the creation means grants a point to a customer with registration information on, calculates discount price according to the point, and set the discount price as incentive information.

The updating means updates registration information according to registration/deletion report from the buddy list system. The registration report is a report that is sent from the buddy list system to this device when a customer registers an advertiser in his buddy list as his buddy. The deletion report is a report that is sent from the buddy list system when the customer deletes the advertiser from his buddy list.

A tenth aspect of the present invention provides the advertisement device according to the eighth aspect, wherein the customer table further stores personal information and customer types decided according to the personal information;

the advertisement table further stores advertisement data created for each of the customer types; and

the registration means further decides a customer type a customer belongs to according to his/her personal information;

writes the customer type decided in the customer table;

directs the buddy list system to allow the customer to obtain the advertisement data based on the customer type; and

registers the advertisement data based on the customer type over the buddy list system.

For example an advertiser sets a customer type according to purchased items and stores advertisement data.

The advertiser registers customers according to his/her customer type in a buddy list created for each of customer types. The advertiser sets advertisement data prepared for each of customer types as status information of the advertiser in each of buddy lists of the advertiser. The buddy list system distributes the advertiser's status information to customers registering the advertiser as their buddy. However, status information to be distributed differs according to customer types the customers belong to. Incidentally, as well as purchase history, various information such as sex, age, address, and hobbies of customers may be used as the personal information.

An eleventh aspect of the present invention provides the advertisement device according to the eighth aspect, further comprising the customer tables and advertisement tables for a plurality of advertisers.

This advertisement device performs the above-mentioned processings. Customers and advertisement data of each advertiser are stored in respective customer tables and advertisement tables.

A twelfth aspect of the present invention provides a computer terminal that can send data to and receive it from an advertisement device storing customer information on customers of an advertiser, comprising:

an input means accepting input of customer information of one of the customers comprising a customer ID allotted to the customer by the advertiser and/or an ID for identifying the customer over a buddy list system; and

a report means reporting the accepted customer information to the advertisement device.

An advertisement device is configured by connecting the terminal to the above-mentioned advertisement device via a network. This terminal is installed in, for example, a shop.

It is conceivable that examples of customer are the above-mentioned customer ID, buddy ID, or personal information. Furthermore, this terminal may obtain data indicating purchase history from the advertisement device and output incentive to be provided for the customer. Incentive is, for example, a giveaway or discount price.

A thirteenth aspect of the present invention provides a computer-readable recording medium recording an advertisement program used for an advertisement device connectable to a buddy list system, for executing steps of:

a step for storing customer IDS for identifying customers of an advertiser and IDS for identifying the customers over the buddy list system (hereinafter referred to as buddy ID) in a customer table;

a step for storing advertisement data in an advertisement table the advertiser distributes to the customers;

a step for updating the customer table if a new customer appears; and

a step for registering the advertisement data which is status information of the advertiser, and the customers in a buddy list of the advertiser.

A fourteenth aspect of the present invention provides a computer-readable recording medium recording a registration program used by a computer terminal that can send and receive data to and from an advertisement device storing customer information on customers of an advertiser, for executing steps of:

a step for accepting input of customer information of one of the customers including a customer ID allotted to the customer by the advertiser and/or an ID for identifying the customer over a buddy list system; and

a step for reporting accepted customer information to the advertisement device.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is an overall configuration diagram of the present invention;

FIG. 2 is a block diagram indicating an advertisement server;

FIG. 3 is a conceptual explanatory diagram of information stored in customer DB;

FIG. 4 is a conceptual explanatory diagram of information stored in shop information DB;

FIG. 5 is a block diagram showing a function of shop terminal;

FIG. 6 is an explanatory diagram showing flow of registration processing of customer DB;

FIG. 7 is a conceptual explanatory diagram of record newly registered in customer DB;

FIG. 8 is a flowchart showing flow of customer DB updating processing 1 (changing registered information);

FIG. 9 is a flowchart showing flow of advertisement processing;

FIG. 10 is a flowchart showing flow of customer DB updating processing 2 (changing customer type);

FIG. 11 is an explanatory diagram showing flow of processing on purchase;

FIG. 12 is a display example of an advertisement on a buddy list;

FIG. 13 is another example of a function of an advertisement server; and

FIG. 14 is an explanatory diagram of a buddy list system.

### DETAILED DESCRIPTION OF THE PREFERRED EMBODIMENTS

<Overview of the Invention>

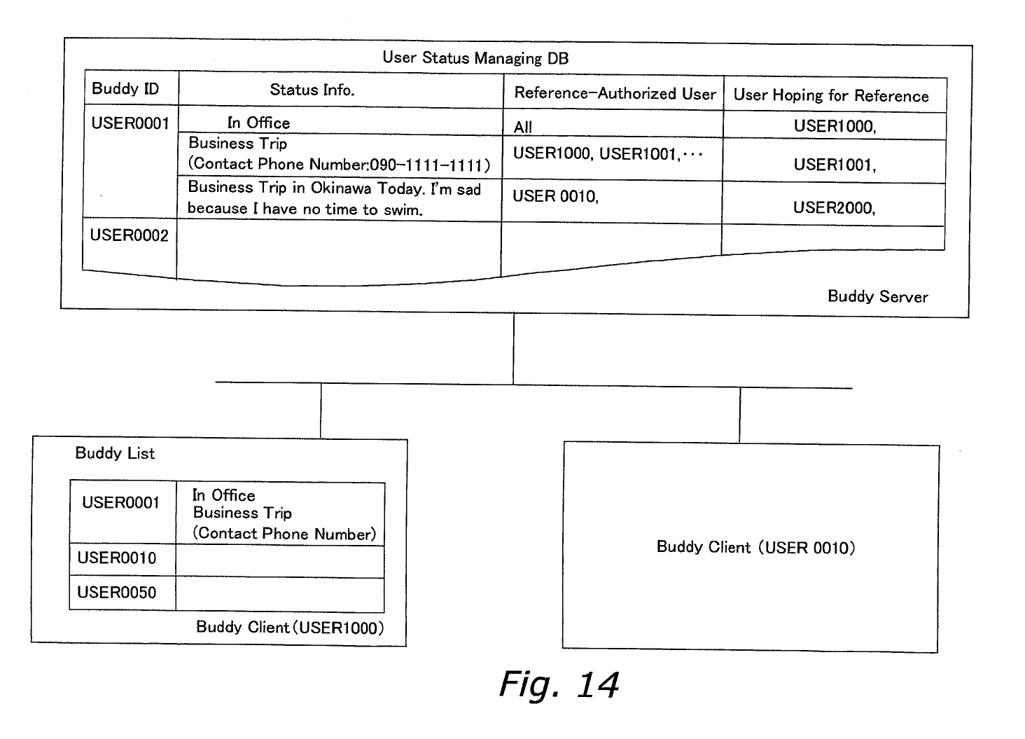

A destination-display system used in a company's office and presence managing system are concrete examples of a status information managing system. This embodiment explains an example using a buddy list system broadly used in these years. As shown in FIG. 14, a buddy list system consists of a buddy server managing status information of a user and a plurality of user terminals connected to each other via a network.

User A registers information on his status in the buddy server with his terminal. In this occasion, user A can also set destination of registered status information, i.e. disclosure level. User A further registers a group of other users user A needs to refer to status information thereof. This group is called a buddy list.

The buddy server correlatively stores status information of user A reported from user terminal A and destination of status information. The buddy server also stores that user A hopes for distribution of status information of users B, C, D, . . . registered in a buddy list according to the buddy list reported from user terminal A. As mentioned above, the buddy server correlatively stores status information of user A when received the status information and reports updated status information to a destination of the status information of user A.

Meanwhile, user terminal A updates displayed status information of users B, C, D, . . . when activating the buddy list system. If the buddy list system is not activated, user terminal A obtains and then displays latest status information at the time of activation.

Namely, the buddy list system displays status of a previously-registered buddy on a list by registering a user to be referred to as a buddy as well as registering self status on a user terminal. The buddy list system also automatically changes displayed status information when status information of a buddy being referred to changes. A user can freely refer to another user in whom the user is interested by connecting to the buddy list system and registering the user in the buddy list.

In the present invention an advertisement from an advertiser is distributed as status information of the advertiser on the buddy list system. A customer seeing the advertisement is less antipathetic to the advertisement because the customer registers the advertiser in the buddy list. To facilitate registration of an advertiser in a customer's buddy list, some incentives are provided for a customer. To simplify the following explanation, it is assumed that an advertiser sells goods in his shop and advertisement is distributed to his customer.

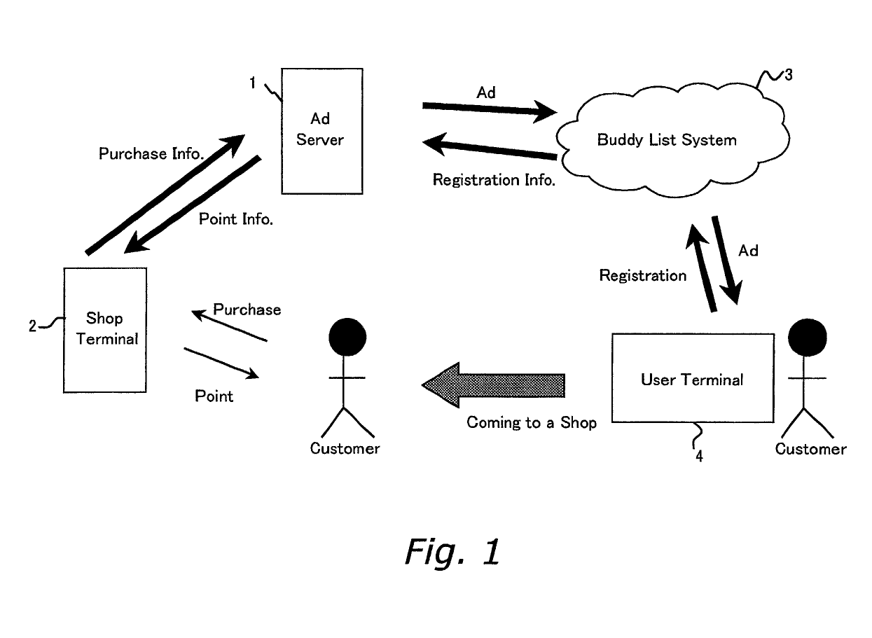

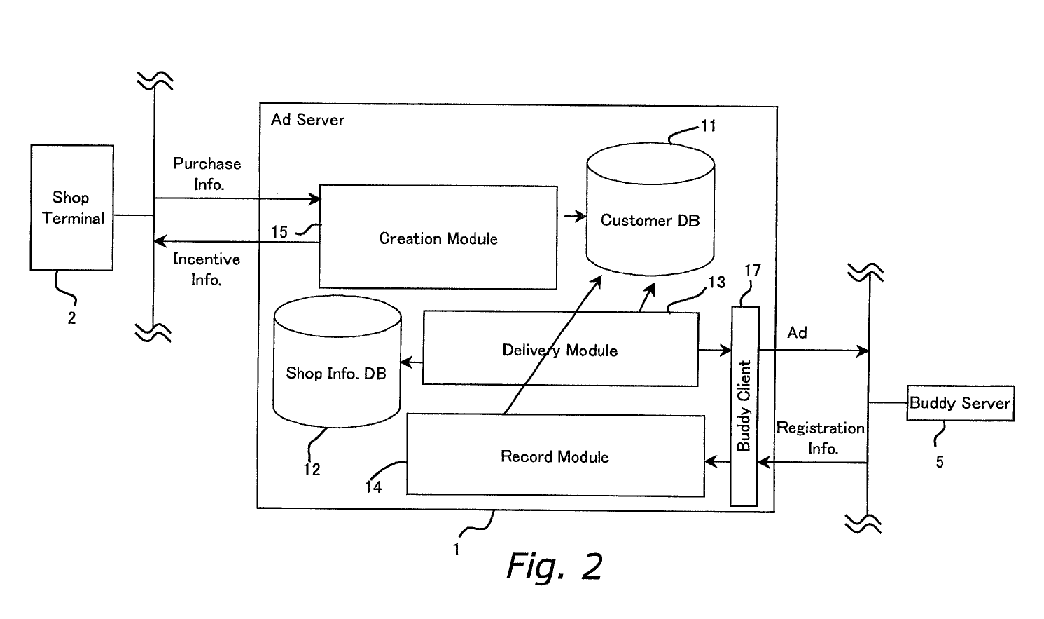

FIG. 1 is an overall configuration diagram of an advertisement system according to the present invention. The system consists of an advertisement server 1 of the advertiser, shop terminal 2 installed in the advertiser's shop, and buddy list system 3, connected to each other via a network. A buddy client, which is not shown in the figure, is installed in user terminal 4 used by a customer. The buddy list system 3 includes buddy server 5 (refer to FIG. 2). Only one shop terminal 2 is shown in the figure. However, a plurality of customer terminals 2 can be connected to the advertisement server 1. The advertisement server 1 and the customer terminal 2 may be the same one computer.

In the advertisement system, when a new customer appears in a shop, the customer is registered in the advertisement server 1 from the shop terminal 2. A shop buddy ID is reported to the customer with duplicate copy of an application form of a point card, contents written in the point card, printing on a receipt, etc. The advertisement server 1 sets an advertisement to the buddy server 5 as a status of the advertiser. When the customer registers the advertiser in his buddy list, the advertisement is distributed to the user terminal 4. And also, buddy ID may be reported to the customer with telecommunication method such as web.

In this way, advertiser must be registered in a customer's buddy list to distribute an advertisement via the buddy list system 3. Therefore the advertisers provide incentives for a customer registering the advertisers in his buddy list (hereinafter referred to as registration customer). As an incentive, it is conceivable that premium is added to a point given to registration customer according to his purchase history.

For example, the shop terminal 2 inquires cumulative point of the relevant customer of the advertisement server 1. If the customer is a registration customer, the advertisement server 1 reports premium rate of the cumulative point to the shop terminal 2. The shop terminal 2 decides privileges such as discount price and giveaways according to reported premium rate and cumulative point. The advertisers can expect increase in number of the registration customers as fruits of incentive.

If personal information of customers and their purchase history are stored beforehand in the advertisement server 1, customers can be classified according to the information. Status information of advertisers registered in each customer's buddy list, i.e. advertisement is separately set for each classification. The advertisement server 1 sends instructions to the buddy list system so that the customers can obtain advertisements corresponding to classifications which the customers belong to. Specifically, users corresponding to an attribute of each classification are extracted according to information registered in customer DB and status information set for each classification and the extracted users are reported to the buddy list system. With this, advertisements suitable to characteristics of customers can be distributed.

First Embodiment

The following specifically explains embodiments of the present invention. In this embodiment, buddy clients work with a phone, e-mail, and WWW browser. A user and buddies can communicate with each other on a buddy list by selecting a communication means from a phone, e-mail, and WWW browser.

Configuration

(1) Advertisement Server

FIG. 2 is a block diagram showing functions of an advertisement server of the above-mentioned advertisement system in FIG. 1 (hereinafter referred to as server). The server 1 has customer DB 11, shop information DB 12, delivery module 13 (registration means), record module 14 and creation module 15. The server 1 also has buddy client 17 and can request from the buddy server 5 setting of advertiser's status and setting of users permitting reference of their statuses. The following explains information stored in the customer DB 11 and the shop information DB 12.

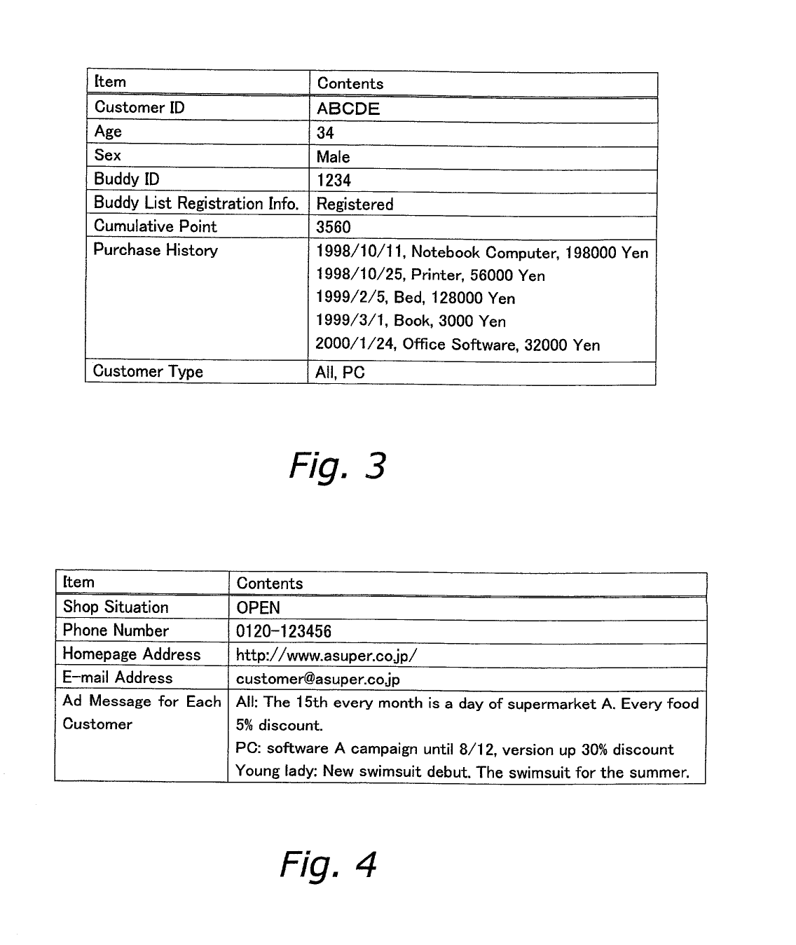

FIG. 3 is a conceptual explanatory diagram stored in the customer DB. Customer ID, age, sex, buddy ID, buddy list registration information, cumulative points, purchase history and customer type are stored in the customer DB 11 for each customer. “Customer ID” is identification information allotted to each customer for an advertiser to identify a customer. “Buddy ID” is identification information to identify a user on a buddy list system.

“Buddy list registration information” shows whether or not a customer is a registration customer. If it is “registered,” the customer registers an advertiser in his buddy list, that is the customer is a registration customer. If it is “not registered,” the customer is an unregistration customer. “Cumulative points” is a cumulative value of points currently given to a customer by an advertiser. “Purchase history” is a set of purchase information of a customer. In this embodiment, purchase history consists of purchase date, purchase item, and price.

“Purchase type” is a classification set by an advertiser to classify customers. Sometimes a plurality of types may be set to a customer. For example, it is conceivable that “all” is set as a type for designating all customers, “PC” is set as a type for designating a customer who purchased PC-related items and “young lady” is set as a type for designating young ladies.

Which type a customer corresponds to can be determined by information stored in the customer DB. For example, if a customer is a woman and her age is 18 or more and 30 or less, the customer's type is “young lady.” If a customer purchased three or more PC-related items, his type is “PC.” All customers belong to “all.” Types a customer belongs to varies according to his age and purchase history.

FIG. 4 is a conceptual explanatory diagram of information stored in the shop information DB 12. In the shop information DB 12, information on an advertiser is stored. In this example, shop status, phone number, homepage address, e-mail address and by-customer-type advertisement message are stored.

“Shop status” represents situation of business transaction in the relevant shop and is “OPEN” representing the shop is open, “SALE” representing the shop is open and holds a bargain sale, or “CLOSED” representing the shop is closed.

In “phone number,” a phone number of an advertiser is set to deal in inquiry of a customer by phone. A purpose for this is to enable the customer to freely call the advertiser from his buddy list. In “homepage address”, a homepage address of an advertiser is set. A purpose of this is to enable the customer to easily refer to the homepage from his buddy list. In “e-mail address,” an e-mail address for an advertiser to deal in inquiry of a customer is set. A purpose for this is to enable the customer to freely send e-mail to the advertiser from his buddy list.

In “by-customer-type advertisement message,” a pair of customer type and advertisement message is stored. In this example, an advertisement message for customer types “PC” and “young lady” in addition to an advertisement message for customer type “all” are separately set. An advertisement message corresponding to customer type as well as an advertisement message for “all” is sent to a customer belonging to “PC” or “young lady.”

The server 1 has the following functions in addition to the above-mentioned customer DB 11 and customer information DB 12. The delivery module 13 refers to the customer DB 11 and shop information DB 12 and sends advertisement data to the buddy list system 3. The record module 14 receives registration/deletion report from the buddy list system and updates customer DB. The registration/deletion report is a report indicating that a customer registered an advertiser in his buddy list as a buddy or the registration was deleted. The creation module 15 mainly refers to buddy list registration information in the customer DB 11 and determines cumulative point number and premium rate of points.

(2) Shop Terminal

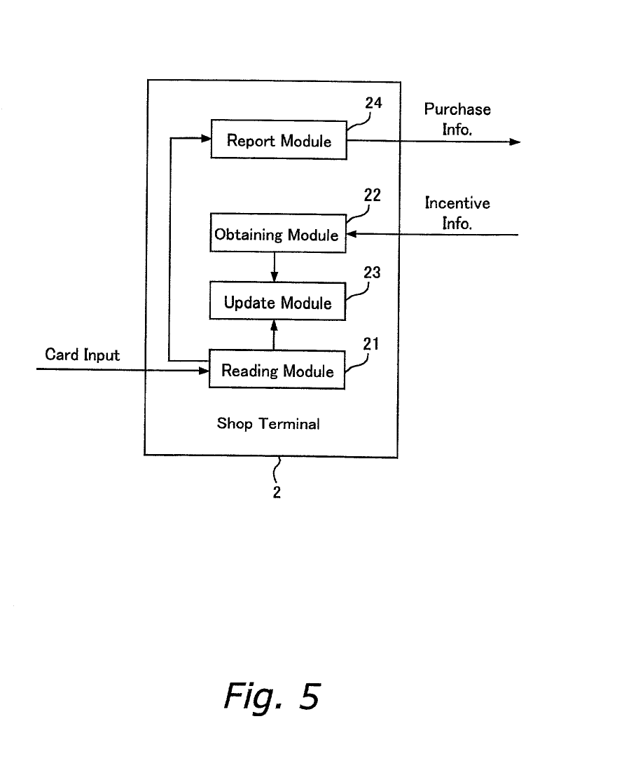

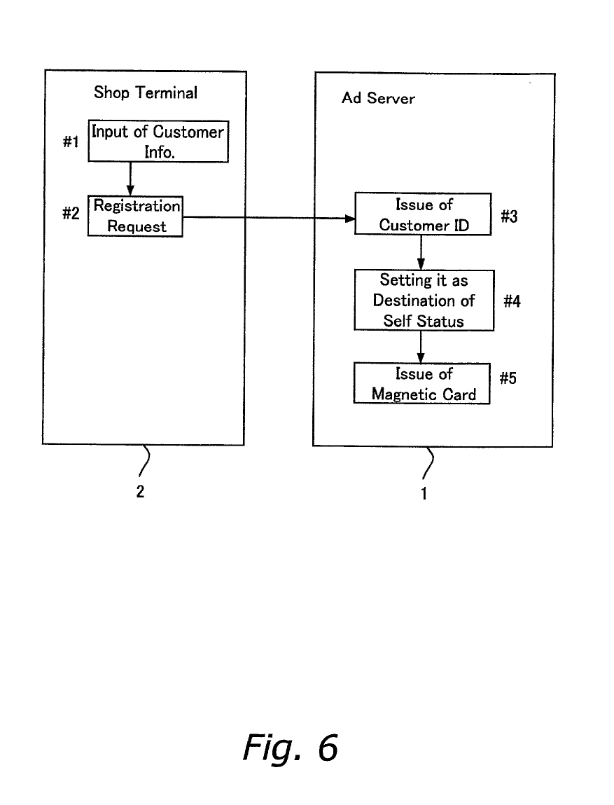

FIG. 5 is a block diagram showing functions of the shop terminal 2. The shop terminal 2 has reading module 21, obtaining module 22, update module 23, and report module 24. The reading module 21 mainly has a function reading customer ID from a magnetic card issued to a customer by an advertiser. The reading module 21 further accepts input of customer information and sends the information to the server 1. Incidentally, an advertiser issues a magnetic card where customer ID is magnetically recorded to a new customer in this example. If a customer purchases in a shop, customer ID can be read from his magnetic card by the shop terminal. Advertiser's buddy ID is expressed in this card and the customer can register the advertiser as his buddy by referring to the ID.

The obtaining module 22 obtains predetermined incentive information from the server 1 i.e. cumulative point number and its premium rate. The update module 23 updates a cumulative points of a customer according to cumulative point obtained from the server 1 when he purchases something and reports the cumulative points to the server 1. Incidentally, the function updating the cumulative points can be performed on the server 1. The report module 24 reports purchase information of a customer to the server 1. The server 1 updates the customer DB and changes an advertisement for the customer according to the report.

Process Flow

The following explains process flow of the advertisement system. As is the case with usual users, buddy ID for identifying a user is allotted to an advertiser. Operation that a customer registers an advertiser in a buddy list is performed by specifying buddy ID of the advertiser as usual.

(1) Registration Processing in Customer DB

The following explains registration processing of a new customer in customer DB 11. A shop receives customer's age, sex, and buddy ID from the customer (#1) and an operator inputs it in the shop terminal 2. The inputted information is sent to the server 1 with registration request at the server 1 (#2).

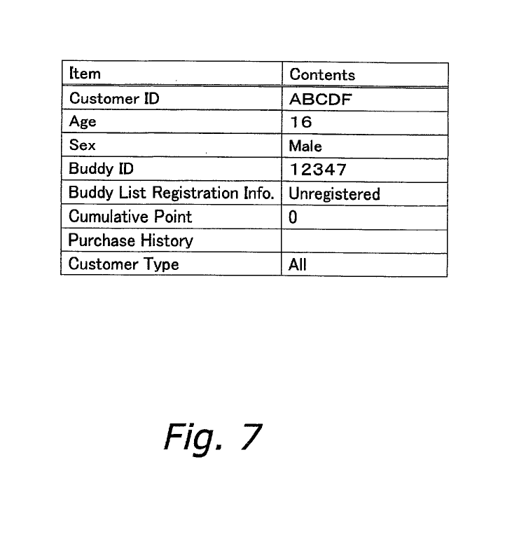

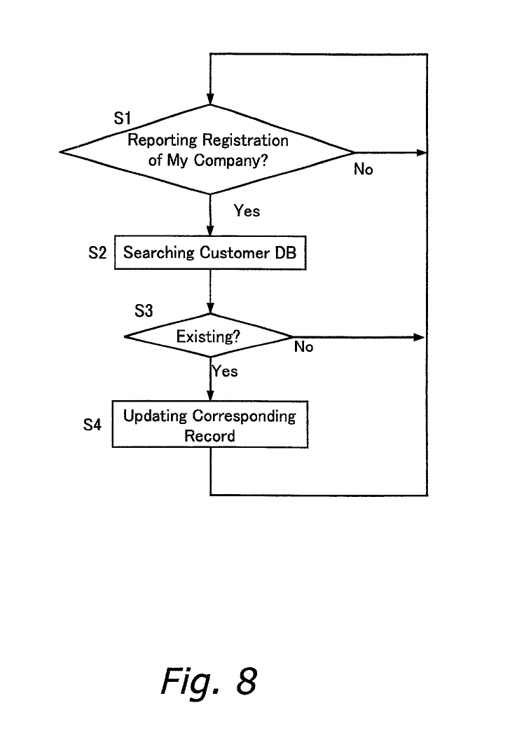

The server 1 received the above-mentioned registration request issues a new customer ID (#3) and creates a new record for a new customer in the customer DB 11. FIG. 7 shows a value of the record. A value received from the customer is inputted in “age,” “sex,” and “buddy ID” of the new record. In the “customer ID,” a newly-issued value “ABCDF” is set. Predetermined default values are set in other information.

The server 1 requests the buddy server 5 to add a new customer to destination of a self status for a customer type “all” i.e. requests the buddy server 5 that the new customer obtain an advertisement (#4). Furthermore, the server 1 issues a magnetic card to the new customer (#5). As described above, buddy ID of the advertiser and customer ID are recorded in the magnetic card.

(2) Customer DB Update Processing 1 (Changing Buddy List Registration Information)

The customer who received the magnetic card issued by the advertiser registers the advertiser in his buddy list as his buddy as he registers his friend in his buddy list. After the registration, a registration report is sent to the server 1 from the buddy server. The record module 14 performs the following steps according to the report.

Step S1: The server 1 waits for a registration report from the buddy server. The server 1 commences processing from S2 onward when receiving the report. The registration report includes buddy ID of a customer who registered the advertiser in his buddy.

Step S2: The server 1 searches for a corresponding customer's record by the buddy ID received with the registration report.

Steps S3 and S4: If the corresponding customer's record exists (S3), the server 1 updates the record (S4) i.e. sets the buddy list registration information of the corresponding record to “registered.” Thereby, the customer becomes a registration customer and an incentive is provided for him on his purchase thereafter. If the corresponding customer's record does not exist (S3), step S1 starts again and the server 1 waits for a next report.

The above-mentioned explanation is based on a case that the advertiser is registered in the buddy list; however, processing in case that the advertiser is deleted from the buddy list is similar to the above-mentioned processing. In this case, deletion report instead of registration report is sent from the buddy server and the buddy list registration information becomes “unregistered.”

(3) Advertisement Processing

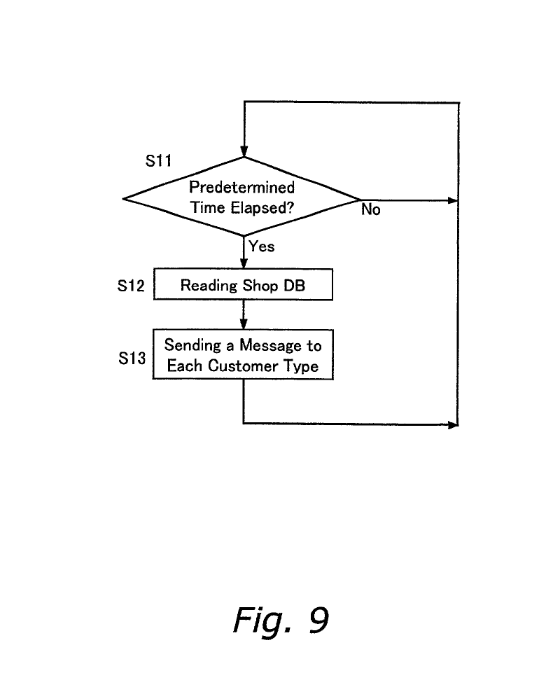

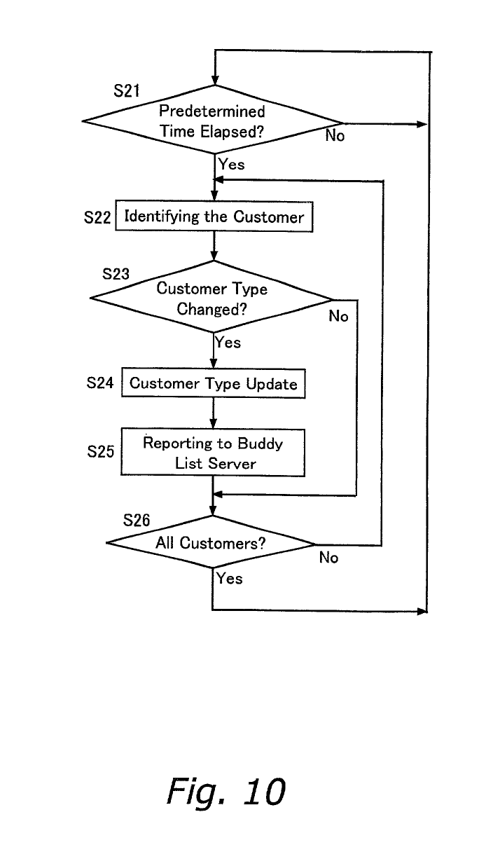

FIG. 9 is a flowchart showing flow of advertisement processing performed by the server 1. The server 1 distributes an advertisement to a customer who became a registration customer by using the buddy list system 3. To distribute the advertisement, the server 1 periodically sends the advertisement to the buddy server by using the sending module 15.

Step S11: The server 1 determines whether or not a predetermined time elapsed and repeats processings from step S12 onward every predetermined time.

Step S12: The server 1 refers to the shop information DB 12 and extracts shop situation, phone number, homepage address and e-mail address. The server 1 also extracts an advertisement message for each customer type.

Step S13: The server 1 creates advertisement information comprising shop situation, phone number, homepage address, e-mail address, and advertisement message for each customer type. Furthermore, the server 1 extracts buddy ID classified into each customer type and sends the created advertisement information and the extracted buddy ID to the buddy server 5. As a result, different status information i.e. different advertisement information is set in a buddy list of each advertiser.

(4) Customer DB Updating Processing 2 (Updating Customer Type)

As described above, advertisement information sent to customers differs depending on customer type to which the customer belongs. However, a customer type to which a customer belongs varies according to customer information e.g. purchase history. To enhance advertisement effect, customers must be classified according to latest customer information. Therefore, the server 1 updates customer type to which a customer belongs by using the delivery module 13 every predetermined time.

Step S21: The server 1 determines whether or not the predetermined time elapsed and performs processing from the step S2 onward if the time elapsed.

Step S22: The server 1 specifies a customer to be determined.

Step S23: The server 1 determines whether or not type of the relevant customer should be changed. For example, if the customer newly purchased PC goods, “PC ” must be added to the customer type. In this case, the server 1 determines that the result is “Yes” and step S24 ensues. If it is unnecessary to change the customer type, the server determines that the result is “No” and the below-described step S26 ensues.

Steps S24 and S25: The server 1 updates the customer type (S24). For example, “PC” is newly written in the customer type. The server 1 reports the buddy server 5 that destination of status information is changed (S25). Specifically, if a customer type “PC” is added to the customer type, the buddy server is reported that the customer should be added to destination of the status information “PC.” This report includes buddy ID of the customer.

Step S26: The server 1 determines whether or not the above-mentioned processing is performed for all customers registered in the customer DB 11. If the result is “No,” step S22 starts again and the above-mentioned processing is repeated for a next customer. If the above-mentioned processing is performed for all customers, step S21 starts again and the server 1 waits for a predetermined time to pass.

(5) Flow of Processing on Purchase

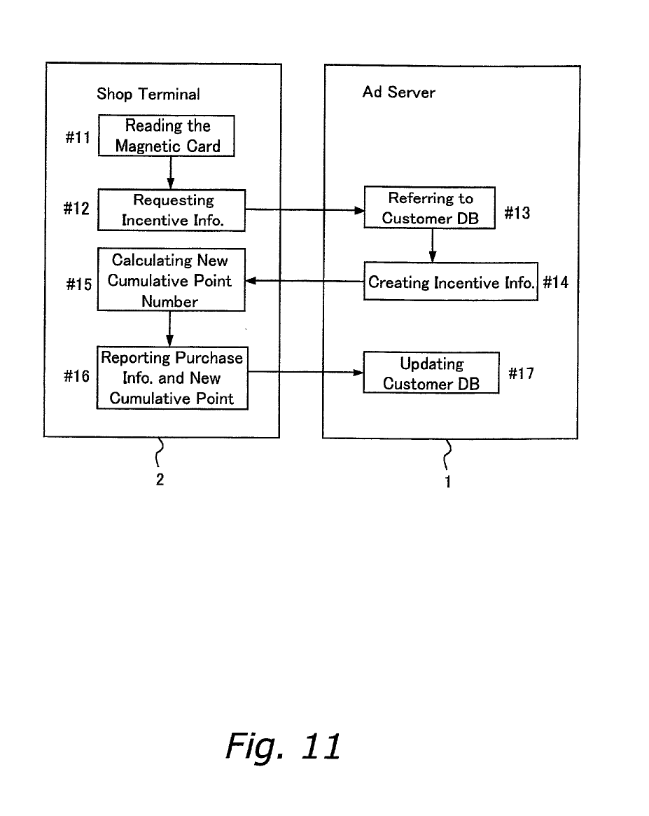

FIG. 11 is an explanatory diagram of a processing performed on purchase. If a customer purchased an item as a result of distribution of an advertisement, purchase history of the customer is reflected to the customer DB 11 of the server 1. According to this, cumulative points are updated and are criteria of privileges provided for the user. Since premium is added to the cumulative point of the registration customer, a customer can be motivated to register an advertisement in his buddy list.

After purchase in a shop, the shop terminal 2 reads a magnetic card of the customer and obtains customer ID (#11). The shop terminal 2 requests incentive information of the customer along with customer ID from the server 1 (#12). Herein incentive information is cumulative points and its premium rate.

The creation module 15 of the server 1 which received the request refers to the customer DB 11 and creates incentive information (#13 and #14). Specifically, the creation module 15 refers to the customer DB 11 by customer ID and reports a number of cumulative points and premium rate of the points to the shop terminal 2. The premium rate is, for example, 0.3 if the customer is a registration customer or 0 if not. If there is not corresponding customer ID, it is reported to the shop terminal 2.

The shop terminal 2 calculates a number of new cumulative points according to cumulative points, consumption points, purchase price, and premium rate (#15). The new number of the cumulative points is calculated, for example, as follows:

New cumulative point=(cumulative point−consumption point)+purchase price×0.01×(1+premium rate)

Incidentally, the more a customer purchases, the more consumption point is given to the customer, and the customer can obtain a giveaway or a price discount of goods, for example, according to the points the customer gained.

The shop terminal 2 reports purchase information and new cumulative point to the server 1 (#16). The server 1 which received the report updates the customer DB 11 with the creation module 15 according to the report (#17). The purchase information updated is used for updating customer type and the point number is used as incentive information on next purchase.

Screen Example

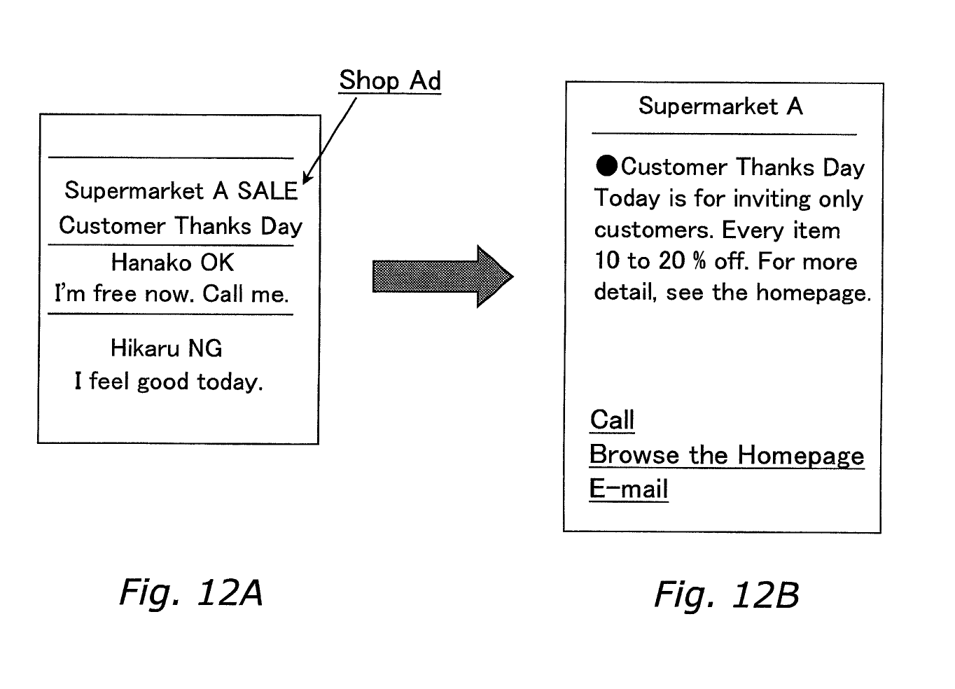

FIG. 12 is an example of an advertisement displayed as status information of an advertiser on a buddy list. In FIG. 12(a), “supermarket A” and its status information “SALE: customer thanks day” are displayed on the buddy list. If a customer would like to know more detailed information, a screen shown in FIG. 12(b) is displayed. In FIG. 12(b), detailed contents of the advertisement are displayed and access to the advertiser by phone, homepage, or e-mail is selectable.

A status information managing system as in the above has been utilized as a help for human communication, and users thereof have been humans. However, in a broad sense, an act of registering a user being concerned about is to register an interesting object and an act of confirming status information of a user by displaying the status information in a list form leads to reference of information on an interesting object at a glance. The act of reference is an active act of a user and information to be referred to is browsed by the user's active act.

In the present invention, an advertiser who is a source of advertisements of shops and manufacturers is registered as one of users of a status information managing system as if the advertiser is a human, and the advertiser registers contents the advertiser wants to advertise and report as advertiser's user status information. Hence, by registering the advertiser as a user having a status information to which other users refer, it is possible to provide a user having a wish with advertisement information from shops or manufacturers as status information.

The advertisers can provide advertisements without making users uncomfortable.

Another Embodiment

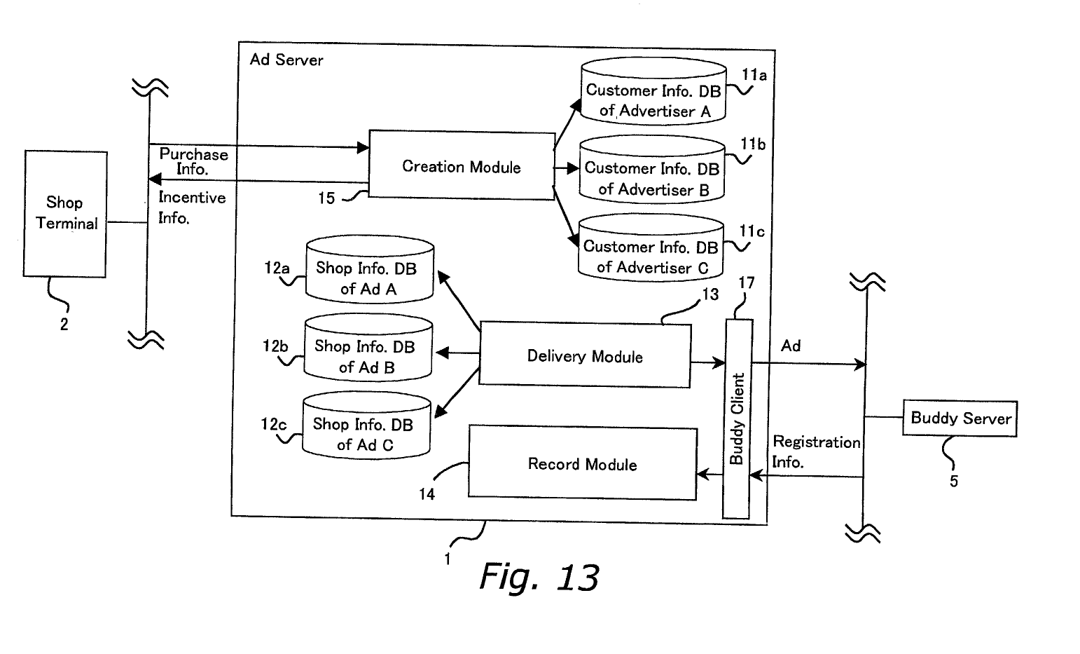

(A) Customers DBs and shop information DB for each of a plurality of advertisers can be provided for the advertisement server 1 in the above-mentioned first embodiment. In other words, a plurality of advertisers can share the advertisement server 1. FIG. 13 is a configuration of advertisement server 1 in this case. The advertisement server 1 has a plurality of DBs 11a, b, and c, and a plurality of shop information DBs 12a, b, and c.

(B) A recording medium storing a program for executing the above-mentioned method is included in the present invention. Herein a computer-readable medium is preferably a floppy disk, hard disk, semiconductor memory, CD-ROM, DVD, MO, etc., which can be read and written by a computer.

Use of the present invention allows direct and easy distribution of advertisement to each customer on a network. The present invention allows change of advertisement contents according to customers when customer information is obtained. Furthermore, the present invention allows contents suitable to latest characteristic of a customer and frequent and active distribution of advertisement.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. An advertisement method using a buddy list system in which a first computer terminal operated by a first user stores in a buddy list a second user operating a second computer terminal connected to said first computer terminal via a network, and said first computer obtains and then outputs said status information of said second user via said network, comprising:
a step for obtaining data of an advertiser hoping for distribution of advertisement data;
a step for presenting said data of said advertiser as an advertiser list on said first user terminal;
a step for selecting said advertiser from said advertiser list and registering said advertiser in said buddy list;
a step for sending said advertisement data as status information of said advertiser registered in said buddy list; and
a step for displaying said advertisement data on said first computer terminal via said network when said first computer terminal is connected to said buddy list system.

2. An advertisement method using a status information managing system that correlatively stores users including a first user operating a first computer terminal and second user operating a second computer terminal and status information of said users, and distributes said status information of said second user to said first computer terminal in response to a request from said first computer terminal, comprising:
a step for registering an advertiser as one of said users over said status information managing system;
a step for storing correlatively in a customer table customers of said advertiser, personal information on said customers, and whether or not each of said customer is an advertisement customer hoping for distribution of advertisement data of said advertiser;
a step for storing correlatively in an advertisement table customer types obtained from said personal information and advertisement data;
a step for registering said first user as an advertisement customer in said customer table if said advertiser receives a report that said first user hopes for distribution of status information of said advertiser;
a step for extracting an advertisement customer from said advertisement table and setting it as a destination when said advertiser distributes status information of said advertiser itself over said status information managing system;
a step for determining advertisement data to be provided for said extracted advertisement customer according to customer type obtained from personal information of said advertisement customer and said advertisement table; and
a step for distributing said advertisement data to said advertisement customer as status information of said advertiser by correlatively reporting said advertisement customer and said advertisement data to said status information managing system.

3. An advertisement device which is used with a status information managing system that correlatively stores users including a first user operating a first computer terminal and second user operating a second computer terminal and status information of said users, and distributes said status information of said second user to said first computer terminal in response to a request from said first computer terminal, comprising:
a connection means connecting to said status information managing system by using an identification number for connecting to said status information managing system;
a customer table correlatively storing customers of an advertiser, personal information on said customers, and whether or not each of said customers is an advertisement customer hoping for distribution of advertisement data of said advertiser;
an advertisement table correlatively storing customer types obtained from said personal information and said advertisement data;
an updating means registering said first user in said customer table as an advertisement customer when receiving a report that said first user hopes for distribution of status information of said advertiser from said status information managing system;
an extraction means extracting said advertisement customer from said advertisement table to set said advertisement customer as a destination if said advertiser distributes status information of said advertiser itself over said status information managing system;
a determination means determining advertisement data to be provided for said extracted advertisement customer according to customer type obtained from personal information of said advertisement customer and said advertisement table; and
a distribution means distributing said advertisement data to said advertisement customer as status information of said advertiser by correlatively reporting said advertisement customer and said advertisement data to said status information managing system.

4. The advertisement device according to claim 3, wherein said customer table further stores purchase history of said customers and said advertisement table further stores advertisement data according to said purchase history.

5. A computer-readable recording medium recording an advertisement program executed on an advertising device, wherein the advertising device is used with a status information managing system that correlatively stores users including a first user operating a first computer terminal and second user operating a second computer terminal and status information of said users, and distributes said status information of said second user to said first computer terminal in response to a request from said first computer terminal, the advertisement program executing:
a step for connecting to said status information managing system by using an identification number for connecting to said status information managing system;
a step for correlatively in a customer table customers of an advertiser, personal information on said customers, and whether or not each of said customer is an advertisement customer hoping for distribution of advertisement data of said advertiser;
a step for storing correlatively in an advertisement table customer types obtained from said personal information and said advertisement data;
a step for registering said first user in said customer table as an advertisement customer when receiving a report that said first user hopes for distribution of status information of said advertiser from said status information managing system;
a step for extracting said advertisement customer from said advertisement table to set said advertisement customer as a destination if said advertiser distributes status information of said advertiser itself over said status information managing system;
a step for determining advertisement data to be provided for said extracted advertisement customer according to customer type obtained from personal information of said advertisement customer and said advertisement table; and
a step for distributing said advertisement data to said advertiser customer as status information of said advertiser by correlatively reporting said advertisement customer and said advertisement data to said status information managing system.

6. A computer terminal which can send and receive data to and from an advertisement device storing customer information on customers of an advertiser, comprising:
an input means accepting input of customer information of one of said customers including a customer ID allotted to said customer by said advertiser and/or a system ID for identifying said customer over a status information managing system; and
a report means reporting customer information accepted to said advertisement device.

7. An advertisement method using a buddy list system where a first user registers a second user in a buddy list whom said first user would like to refer to in a buddy list, obtains status information of said second user, and thus can refer to said status information of said second user; comprising:
a step for registering advertisement data as status information of an advertiser to be distributed over said buddy list as status information of said advertiser; and
a step for distributing said advertisement data to said advertiser's customers by using said buddy list system.

8. An advertisement device connectable to a buddy list system for a first user to refer to status information of a second user, comprising:
a customer table storing customer IDs for identifying each of customers of an advertiser and IDS for identifying said customers over a buddy list system (hereinafter referred to as buddy ID);
an advertisement table storing advertisement data said advertiser distributes to said customers;
updating means updating said customer table when a new customer appears; and
a registration means registering said advertisement data in said buddy list system.

9. The advertisement device according to claim 8, wherein said customer table further stores registration information indicating whether or not each of said customers registers said advertiser in his/her buddy list;
said updating means further updates said customer table when said buddy list system reports that said registration information is changed; and
said updating means further comprises a creation means creating incentive information for said customer according to said registration information.

10. The advertisement device according to claim 8, wherein said customer table further stores personal information and customer types decided according to said personal information;
said advertisement table further stores advertisement data created for each of said customer types; and
said registration means further decides a customer type a customer belongs to according to his/her personal information;
writes said customer type decided in said customer table;
directs said buddy list system to allow said customer to obtain said advertisement data based on said customer type; and
registers said advertisement data based on said customer type over said buddy list system.

11. The advertisement device according to claim 8, further comprising said customer tables and advertisement tables for a plurality of advertisers.

12. A computer terminal that can send data to and receive it from an advertisement device storing customer information on customers of an advertiser, comprising:
an input means accepting input of customer information of one of said customers comprising a customer ID allotted to said customer by said advertiser and/or an ID for identifying said customer over a buddy list system; and
a report means reporting said accepted customer information to said advertisement device.

13. A computer-readable recording medium recording an advertisement program used for an advertisement device connectable to a buddy list system, for executing steps of:
a step for storing customer IDs for identifying customers of an advertiser and IDs for identifying said customers over said buddy list system (hereinafter referred to as buddy ID) in a customer table;
a step for storing advertisement data in an advertisement table said advertiser distributes to said customers;
a step for updating said customer table if a new customer appears; and
a step for registering said advertisement data which is status information of said advertiser, and said customers in a buddy list of said advertiser.

14. A computer-readable recording medium recording a registration program used by a computer terminal that can send and receive data to and from an advertisement device storing customer information on customers of an advertiser, for executing steps of:
a step for accepting input of customer information of one of said customers including a customer ID allotted to said customer by said advertiser and/or an ID for identifying said customer over a buddy list system; and
a step for reporting accepted customer information to said advertisement device.
